(19) United States
(12) Patent Application Publication
(10) Pub. No.: US 2004/0205280 A1
(43) Pub. Date: Oct. 14, 2004

(54) End-point sharing of communication bus interface

(76) Inventors: Jeffrey K. Jeansonne, Houston, TX (US); Tim L. Zhang, Spring, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/411,009

(22) Filed: Apr. 10, 2003

(51) Int. Cl. G06F 13/36

(52) U.S. Cl. 710/306

(57) ABSTRACT

A computer peripheral comprises a bus interface to a communication bus, a first component-bus bridge communicable with the bus interface and a first endpoint adapted for communication with a first component, a second component-bus bridge different from the first component-bus bridge and communicable with the bus interface and a second endpoint adapted for communication with a second component, and an automatic endpoint selector responsive to a control signal and adapted to enable one and disable the other of the first and second component-bus bridges for sharing the bus interface.

### BACKGROUND

Computer systems and other electronic devices often have a communication bus to facilitate communication with peripheral devices, such as printers, scanners, mice, joysticks, digital cameras, optical drives, floppy disk drives, and so forth. Depending on the particular application, these systems and devices may have one or more bus architectures, each having one or more communication interfaces or ports. For example, a Universal Serial Bus (USB) may have one or more USB ports, while an Institute of Electrical and Electronics Engineers (IEEE)-1394 bus may have one or more IEEE-1394 ports. Each peripheral device also has a communication interface or port. Accordingly, the peripheral device may be communicatively coupled to the desired system or device via a communication cable, which plugs into the communication interfaces or ports at the peripheral device and the desired system or device. If multiple devices are desired at the peripheral end of the communication cable, then a communication hub may be provided with multiple communication interfaces or ports. Unfortunately, a hub adds cost and relatively complex control circuitry to the communication bus.

### SUMMARY

According to one embodiment, a computer peripheral comprises a bus interface to a communication bus, a first component-bus bridge communicable with the bus interface and a first endpoint adapted for communication with a first component, a second component-bus bridge different from the first component-bus bridge and communicable with the bus interface and a second endpoint adapted for communication with a second component, and an automatic endpoint selector responsive to a control signal and adapted to enable one and disable the other of the first and second component-bus bridges for sharing the bus interface.

In another embodiment, a system comprises a peripheral device communicatively coupled to a processor-based device via a communication bus, an interface to the communication bus, a housing adapted to receive at least one selected component of a plurality of components, a first component-bus bridge communicable with the interface, a second component-bus bridge different from the first component-bus bridge and communicable with the interface, and an automatic selector responsive to insertion of the at least one selected component and adapted to enable one and disable the other of the first and second component-bus bridges.

A further embodiment comprises a method of communicating with a multi-component device comprises engaging one interface of different component interfaces upon a component event, and switchably bridging the one interface between the different component interfaces with a communication bus interface in response to the component event.

### BRIEF DESCRIPTION OF THE DRAWINGS

Embodiments will hereafter be described with reference to the accompanying drawings, wherein like reference numerals denote like elements, and:

FIG. 1 is a perspective view illustrating a computer system in accordance with certain embodiments of the present invention

FIG. 2 is a diagram illustrating a communication system and automatic endpoint selector for mutually exclusively sharing a single communication interface or port in accordance with certain embodiments of the present invention;

FIG. 3 is a diagram illustrating an alternative embodiment of the communication system and automatic endpoint selector of FIG. 2;

FIG. 4 is a diagram illustrating an alternative embodiment of the automatic endpoint selector of FIGS. 2 and 3;

FIG. 5 is a diagram illustrating another alternative embodiment of the automatic endpoint selector of FIGS. 2 and 3;

FIG. 6 is a diagram illustrating a further alternative embodiment of the automatic endpoint selector of FIGS. 2 and 3;

FIG. 7 is a flow chart illustrating a communication sharing process in accordance with certain embodiments of the present invention;

FIG. 8 is a flow chart illustrating a process of forming a multi-component device in accordance with certain embodiments of the present invention; and

FIG. 9 is a block diagram illustrating a multi-component device and automatic endpoint selector in accordance with certain embodiments of the present invention.

### DETAILED DESCRIPTION

As described in detail below, unique systems and methods are provided in which multiple components share a single communication interface to a communication bus without implementation of a communication hub. The multiple components may comprise removable computer drives, swappable components, or other computer components such as modular storage and media drives. Accordingly, a hubless communication switch or automatic endpoint selector responds to a component event or control signal, which triggers a mutually exclusive selection of one of multiple endpoints that may be coupled with the single communication interface. If a particular component becomes active and the remaining components inactive, then the automatic endpoint selector communicatively couples the single communication interface with the corresponding endpoint for the active component. For example, a selected component may become active (and others inactive) by removing one component and mutually exclusively inserting the selected component into a component bay. The automatic endpoint selector may comprise a variety of simple switches and a control signal corresponding to a component event. For example, the automatic endpoint selector may comprise a multiplexor, an isolation switch, or a variety of hardware switches.

Each of the multiple endpoints comprise translating or bridging circuitry, e.g., a bridge chip, to facilitate communication between different component interfaces and the communication interface of the communication hub. For example, a bridge chip may comprise translating circuitry to facilitate communications between one of the component interfaces and a hubless high-speed bus interface, such as a USB or an IEEE-1394 interface. The different component interfaces may comprise an Integrated Device Electronics (IDE) interface, an Advanced Technology Attachment (ATA) interface, an Advanced Technology Attachment Packet Interface (ATAPI), a floppy drive interface, and so forth.

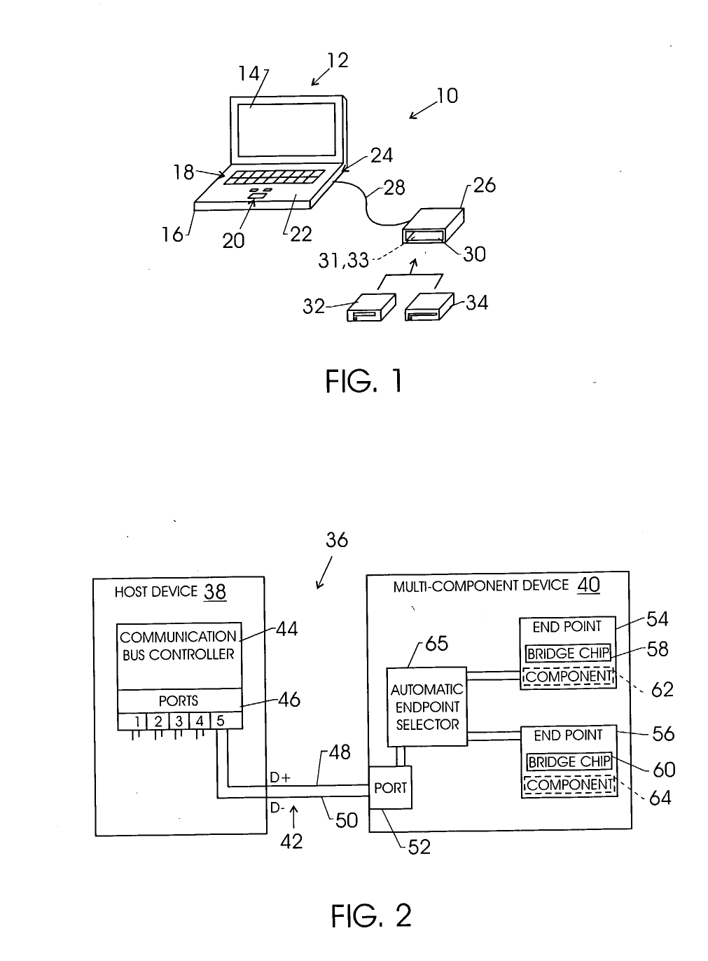

Turning to the drawings, FIG. 1 is a perspective view of a computer system 10 in accordance with certain embodiments of the invention. Although the computer system 10 is illustrated as a laptop computer, the system 10 may comprise any suitable stationary or portable computing device, e.g., a rack mount server, a desktop computer, a tablet computer, a personal digital assistant (PDA), and so forth. As illustrated, the computer system 10 comprises a computing device 12 having a display screen 14 rotatably coupled to a component housing 16, which houses a variety of computing components. For example, the component housing 16 has a keyboard 18 and a pointing device 20 disposed on an upper surface 22 to facilitate user interaction with the computing device 12. The component housing 16 also may have variety of internal computing components, such as one or more processors (e.g., Central Processing Unit), circuit boards, hard drives, random access memory (RAM), audio circuitry, video circuitry, communication circuitry (e.g., modem, network interface card, wireless technology, etc.), and so forth.

One or more external interfaces or ports also may be provided to facilitate external communication with these internal computing components. For example, a communication port or interface 24 may be provided to communicate with a component housing or peripheral device 26 via a wireless transmission path or communication cable 28. As illustrated in FIG. 1, the peripheral device 26 comprises a modular receptacle or bay 30 (e.g., a multi-bay cradle), which is configured to receive a selected one of a variety of computing components 32 and 34 (e.g., modular or swappable components). However, other embodiments are contemplated in which multiple components are disposed within the peripheral device 26. For example, the peripheral device 26 may have one or more additional modular receptacles or bays, such as bays 31 and 33. Several exemplary computing components 32 and 34 comprise a floppy disk drive, a hard disk drive, a Compact-Disc Read-Only Memory (CD-ROM) drive, a Digital-Video-Disc Read-Only-Memory (DVD-ROM) drive, a Compact-Disc Read-Write (CD-RW) drive, and various other optical drives and storage components. Accordingly, the illustrated peripheral device 26 may be described as a multi-component device by way of its ability to receive and function as a variety of computing components. However, other multi-component devices are also contemplated for the unique communication systems and methods described in further detail below.

In multi-component devices such as the peripheral device 26 illustrated in FIG. 1, each of the components 32 and 34 have a different communication interface, such as a floppy disk interface or an Integrated Drive Electronics (IDE) interface. Moreover, the communication interface between the remote or separate devices, i.e., the computing device 12 and the peripheral device 26, also may have a different communication interface than at least one of the components 32 and 34. For example, the communication interface may be a serial bus interface, a Universal Serial Bus (USB) interface, an IEEE-1394 interface, an optical bus interface, a wireless bus interface such as an Infrared interface, and so forth.

FIG. 2 illustrates an embodiment of a communication system 36 comprising a host device 38 communicatively coupled to a multi-component device 40 via a wireless communication path or communication cable 42. In some embodiments, the host device may comprise a stationary or portable computer (e.g., the computing device 12) and the multi-component device may comprise one or more component receptacles (e.g., bays 31, 32, and 33 of peripheral device 26). As illustrated, the host device 38 comprises a communication bus controller 44 having a plurality of communication interfaces or ports 46, which facilitate connection with the communication cable 42. For example, the communication bus controller 44 may comprise a serial bus, a Universal Serial Bus (USB), an IEEE-1394 bus, an optical communication bus, a wireless communication bus (e.g., a Infrared bus, a radio frequency (RF) bus, a blue tooth bus), and so forth. It also should be noted that the communication cable 44 can be eliminated from system 36 if the communication bus controller 44 comprises wireless communication technology. If included in system 36, the communication cable 42 may comprise a twisted differential pair of communication wires, such as 48 and 50, which are labeled as D+ and D−. Moreover, the foregoing USB and IEEE-1394 buses support hot-swapping of devices and high data transfer rates.

The multi-component device 40 is communicatively coupled to the communication cable 42 via a communication interface or port 52, such as a USB or IEEE-1394 port. As discussed above, computing components generally have a communication interface different from that of the communication bus. Accordingly, the multi-component device 40 comprises a plurality of different endpoints 54 and 56 having bridge chips 58 and 60 to facilitate communication between the communication bus or port 52 and the respective components 62 and 64. As illustrated by the hidden lines, the multi-component device 40 may comprise one, both, or none of the components 62 and 64 depending on the particular application and status of the device 40. For example, the multi-component device 40 may comprise the peripheral device 26 having the modular bay 30, such that one of the components 62 and 64 may be disposed mutually exclusively in the multi-component device 40.

The multi-component device 40 of FIG. 2 also comprises an automatic endpoint selector 65, which responds to a control signal or component event to select a mutually exclusive one of the endpoints 54 and 56 for communication with the communication bus or port 52. For example, referring back to the embodiment of FIG. 1, the automatic endpoint selector 65 may be disposed in the peripheral device 26, such that the selector 65 can respond to the insertion of a selected one of the components 32 and 34 and enable the bridge chip 58 or 60 corresponding to that selected and inserted component. Accordingly, the automatic endpoint selector 65 facilitates sharing via mutually exclusive access of the single communication interface or port 52 between the endpoints 54 and 56 without using a hub or other complex circuitry. In response to the component event, the hubless communication switch or automatic endpoint selector 65 enables one of the components 32 and 34, while the selector 65 disables the remaining one of the components 32 and 34.

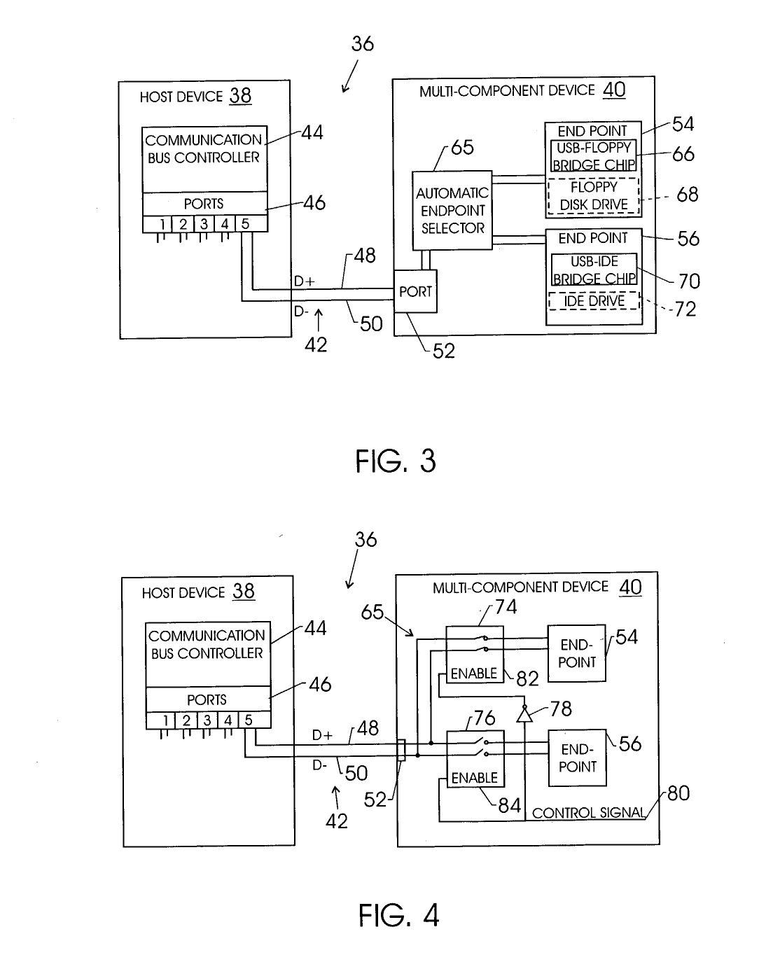

As discussed above, the multi-component device 40 may comprise a wide variety of component types and configurations. FIG. 3 is a block diagram illustrating an alternative embodiment of the communication system 36 of FIG. 2. In the illustrated embodiment, the end point 54 of the multi-component device 40 comprises a USB-Floppy bridge chip or communication translation chip 66, which provides a communication bridge between a floppy disk drive 68 and the communication interface or port 52. Additionally, the end point 56 of the multi-component device 40 comprises a USB-IDE bridge chip or communication translation chip 70, which provides a communication bridge between an Integrated Drive Electronics (IDE) drive or device 72 and the communication interface or port 52. For example, the IDE drive 72 may comprise a hard disk drive or an optical drive, such as a CD-ROM drive, a DVD drive, a CD-RW drive, and so forth. As illustrated by the hidden lines, the multi-component device 40 may comprise one, both, or neither of the floppy disk drive 68 and the IDE drive 70 depending on the particular application and status of the device 40.

Additional embodiments of the communication system 36, and specifically the automatic endpoint selector 65, are illustrated with reference to FIGS. 4-6. Turning to FIG. 4, the automatic endpoint selector 65 comprises a pair of signal-controlled or event-activated switches 74 and 76 disposed between the communication interface or port 52 and the respective endpoints 54 and 56. The event-activated switches 74 and 76 are mutually exclusively enabled or disabled by an inverter 78 and a control signal 80, which control the enable/disable states of enablement controls 82 and 84 of the respective event-activated switches 74 and 76. Accordingly, if the control signal 80 indicates an enablement status, then the enablement status communicates with the switch 76 and enables the control 84, while the inverter 78 changes the control signal 80 directed to the switch 74 to a disablement state that disables the control 82. The reverse occurs for a control signal 80 indicating a disablement status. In this manner, one of the switches 74 or 76 mutually exclusively enables the respective endpoint 54 or 56, while the remaining one of the switches 74 or 76 disables the respective endpoint 54 or 56. Again, the control signal 80 may be triggered by a variety of events, such as insertion of one of the components 32 and 34 into the bay 30 of FIG. 1. Alternatively, if the components are both disposed in the multi-component device 40, then the control signal 80 may correspond to active use of one of the components 32 or 34, while the other one of the components 32 or 34 is inactive.

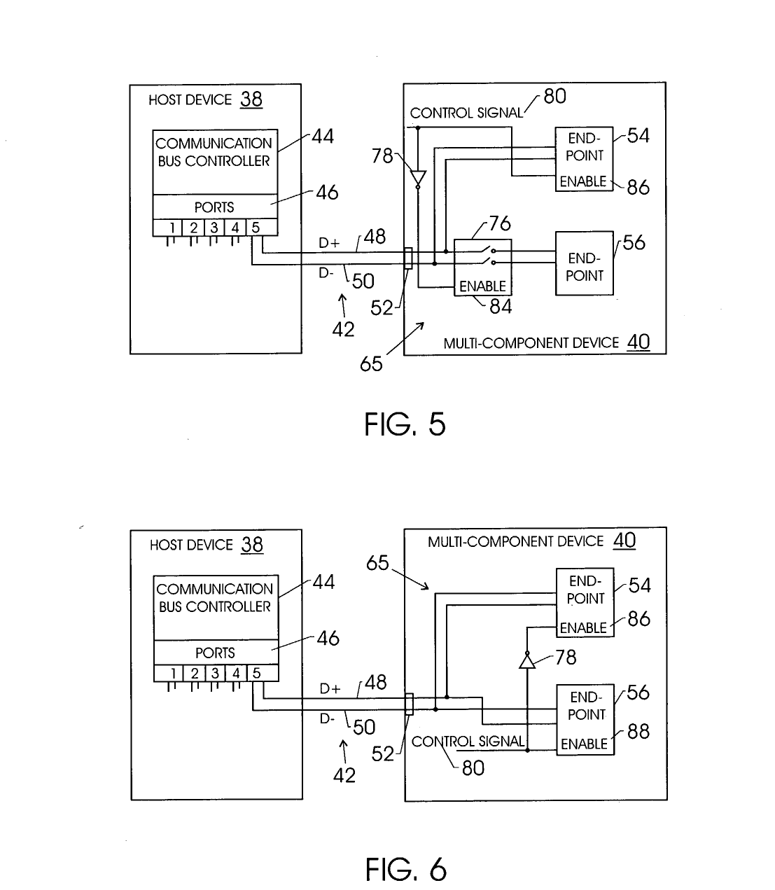

As illustrated in FIGS. 5 and 6, certain components also may be amenable to direct disablement and enablement, rather than using intermediate event-activated switches. For example, as illustrated in FIG. 5, the event-activated switches 74 are omitted from the automatic endpoint selector 65, while the event-activated switch 76 remains between the communication interface or port 52 and the respective endpoint 56. Accordingly, the endpoints 54 and 56 are oppositely enabled or disabled by the control signal 80 and operation of the inverter 78. As discussed above, the control signal 80 directly routes the enable/disable status to the enablement control 86 of the endpoint 54, while the inverter 78 inverts the enable/disable status of the control signal 80 directed to the enablement control 84 of the switch 76 for endpoint 56. By responding directly to the control signal 80, the endpoint 54 isolates itself from the communication interface or port 52 during mutually exclusive use of the port 52 by the endpoint 56. The endpoint 54 also responds directly to the control signal 80 to enable itself, while the event-activated switch 76 disables the endpoint 56. It also should be noted that the endpoints 54 and 56 may be swapped, such that endpoint 54 is coupled to the event-activated switch 76 and the endpoint 56 has an enablement control in direct communication with the control signal 80. Again, the system facilitates sharing via mutually exclusive access of the single communication interface or port 52 between the endpoints 54 and 56. In response to the component event, the hubless communication switch or automatic endpoint selector 65 enables one of the endpoints 54 and 56, while the selector 65 disables the remaining one of the endpoints 54 and 56.

FIG. 6 illustrates an alternative embodiment of the communication system 36, and specifically automatic endpoint selector 65, having both endpoints 54 and 56 directly controlled without the event-activated switches 74 and 76. As illustrated, the endpoints 54 and 56 are mutually exclusively enabled or disabled by the control signal 80 and operation of the inverter 78. As discussed above, the control signal 80 directly routes the enable/disable status to the enablement control 88 of the endpoint 56, while the inverter 78 inverts the enable/disable status of the control signal 80 directed to the enablement control 86 of the endpoint 56. By responding directly to the control signal 80, the endpoint 54 isolates itself from the communication interface or port 52 while the endpoint 56 enables itself for communication with the interface or port 52, and vice versa. Accordingly, the system facilitates mutually exclusive sharing of the single communication interface or port 52 without any hub or switches, thereby reducing the cost and complexity of the shared communication configuration.

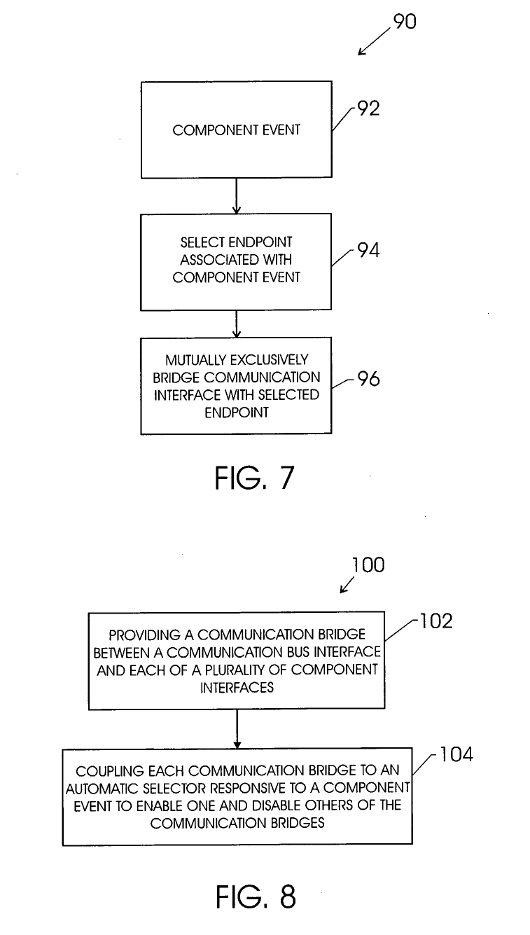

Although a variety of communication systems and sharing processes are contemplated, FIG. 7 illustrates an exemplary process 90 for mutually exclusively sharing a single communication interfaces, such as illustrated in FIGS. 1-6. As illustrated, the process 90 initiates with a component event 92, which may correspond to activating, receiving, or generally interacting with one of multiple components (e.g., components 32, 34, 62, 64, 68, or 72) of the multi-component device or peripheral 26 or 40. For example, the process 90 may trigger the control signal 80 upon inserting the desired component into the multi-component device or peripheral 26 or 40. If multiple devices are disposed within the multi-component device or peripheral 26 or 40, then the component event 92 may correspond to user interaction or computer access to a desired one of the components 32, 34, 62, 64, 68, or 72. The process 90 then proceeds to select one endpoint 54 or 56 associated with the desired component (e.g., components 32, 34, 62, 64, 68, or 72) identified by the component event (block 94). For example, the process 90 may select a component-to-communication bus bridge, such as a Floppy-to-USB bridge or an IDE-to-USB bridge, using one or more switches 74 and 76 and/or direct component controls 86 and 88. The process 90 then proceeds to mutually exclusively bridge the communication interface or port 52 for the communication bus 44 with the selected endpoint 54 or 56 associated with the component event (block 96). Again, the process 90 facilitates sharing via mutually exclusive access of the single communication interface or port 52 with a simple endpoint selector 65, rather than using multiple interfaces of a hub or complex circuitry.

Turning to FIG. 8, a process 100 is illustrated for manufacturing or forming a multi-component device. For example, the process 100 may be used to form the peripheral device 26 or the multi-component device 40 illustrated in FIGS. 1-6. As illustrated, the process 100 proceeds by providing a communication bridge between the communication bus interface and each of the plurality of component interfaces (block 102). For example, the process 100 may provide one or more of the bridge chips 58, 60, 66, and 70 between the communication bus interface or port 52 and the respective component interfaces, e.g., endpoints 54 and 56. Again, the bridge chips may communicatively link, or provide communication translations, between different communication interfaces, such as USB, IEEE-1394, IDE, ATA, ATAPI, Floppy Disk, and so forth. The process 100 then proceeds by coupling each communication bridge to an automatic selector responsive to a component event to enable one and disable others of the communication bridges (block 104). The automatic selector may comprise a control signal (e.g., a high/low control signal), a multiplexor, an isolator switch, a hardware switch, an enable/disable control, and so forth. For example, the automatic selector may comprise an event-activated or control-signal activated isolator or switch, which is operable to enable one and disable others of the communication bridges in response to a component event or control signal.

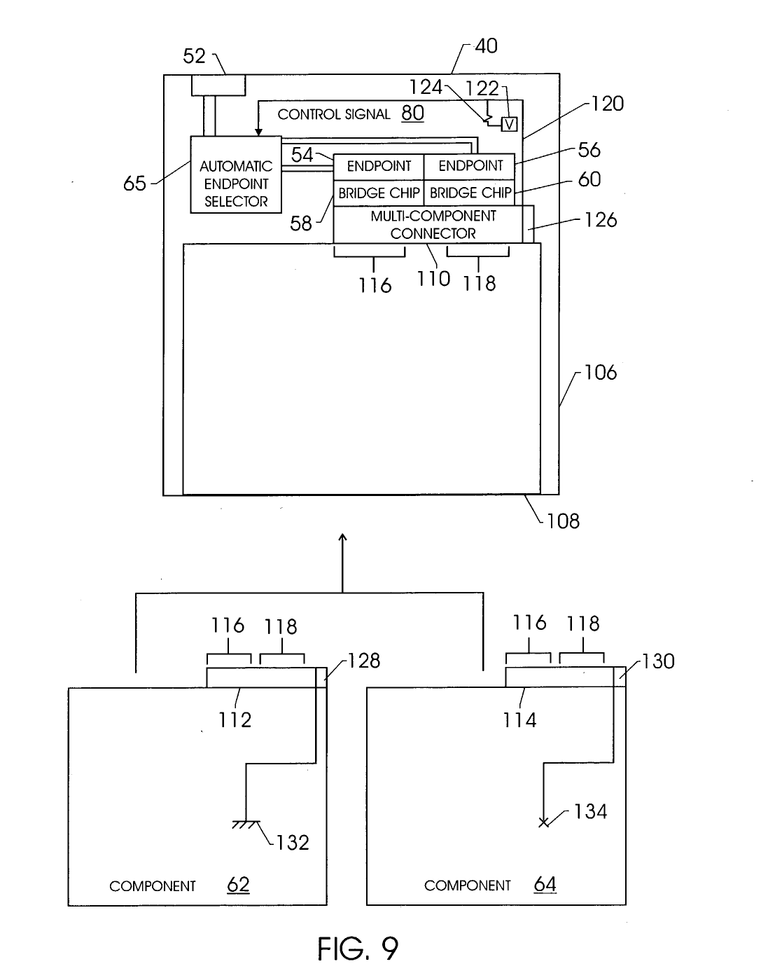

FIG. 9 is a block diagram illustrating an alternative embodiment of the multi-component device 40, the automatic endpoint selection 65, and operation of the control signal 80. As illustrated, the multi-component device 40 comprises a housing 106 having a multi-component receptacle or bay 108 (e.g., multi-bay cradle), which may comprise one, two, three, or any number of component receptacles. Accordingly, one or more components, such as components 62 and 64, may be inserted and housed within the multi-component receptacle or bay 108. Within the multi-component receptacle or bay 108, the multi-component device 40 comprises a multi-component connector 110 that is mateable with a mating connector of the corresponding component 62 or 64. For example, the components 62 and 64 comprise mating connectors 112 and 114, respectively.

As illustrated, the endpoints 54 and 56 are coupled to the multi-component connector 110 at bridge chips 58 and 60, respectively. In one embodiment, the multi-component connector 110 has a different connector section, such as connector sections 116 and 118, for each of the respective endpoints 54 and 56. Similarly, each of the mating connectors 112 and 114 may have the connector sections 116 and 118. For example, each of the multi-component connector 110 and the mating connectors 112 and 114 may comprise N-electrical contacts, pins, or receptacles, while a certain number of those contacts, pins, or receptacles are assigned to each of the connector sections 116 and 118. As discussed in detail above, the endpoints 54 and 56 are also communicatively coupled to the automatic endpoint selector 65, which in turn is coupled to the communication bus interface or port 52.

In the illustrated embodiment, the control signal 80 is transmitted through a control signal lead 120 extending between the automatic endpoint selector 65 and the multi-component connector 110. A voltage 122 is also applied to the lead 120 with an intermediate resistor 124, such that grounding/ungrounding of the lead 120 can provide low/high states of the control signal 80. For example, the voltage 122 may be 5 Volts and the resistor 124 may be 10 Ohms. As illustrated, the control signal lead 120 extends into the multi-component connector 110 via an electrical contact, pin, or receptacle 126, while each of the components 62 and 64 comprises a mating control connector, such as control connectors 128 and 130, respectively. In the component 62, the control connector 128 is grounded at a ground 132. Contrastingly, the control connector 130 of the components 64 is ungrounded, as indicated by reference numeral 134. Accordingly, if the component 62 is inserted into the bay 108 and connectors 126 and 128 are coupled, then the ground 132 drops the voltage 122 to a low state (e.g., 0 Volts). For example, the low state may correspond to a false state or a logical “0” for the control signal 80. In contrast, if the component 64 is inserted into the bay 108 and connectors 126 and 130 are coupled, then the voltage 122 is not grounded and it remains in the high or true state (e.g., a logical “1”) for the control signal 80. In this manner, mutually exclusive insertion of each component 62 or 64 into the respective bay 108 creates a different state of the control signal 80, which the automatic endpoint selector 65 processes to enable one and disable the other of the bridge chips 58 and 60 corresponding to the inserted one of the components 62 or 64. If the multi-component device 40 comprises multiple bays 108, then a similar automatic endpoint selector 65 and control system may be implemented for each respective bay.

What is claimed is:

1. A computer peripheral, comprising:
a bus interface to a communication bus;
a first component-bus bridge communicable with the bus interface and a first endpoint adapted for communication with a first component;
a second component-bus bridge different from the first component-bus bridge and communicable with the bus interface and a second endpoint adapted for communication with a second component; and
an automatic endpoint selector responsive to a control signal and adapted to enable one and disable the other of the first and second component-bus bridges for sharing the bus interface.

2. The computer peripheral of claim 1, wherein the communication bus comprises a universal serial bus.

3. The computer peripheral of claim 1, wherein the communication bus comprises an Institute of Electrical and Electronics Engineers (IEEE)-1394 bus.

4. The computer peripheral of claim 1, wherein the bus interface, the first and second component-bus bridges, and the automatic endpoint selector are disposed in a multi-component housing.

5. The computer peripheral of claim 1, wherein the bus interface, the first and second component-bus bridges, and the automatic endpoint selector are disposed in a device bay.

6. The computer peripheral of claim 1, comprising a selected one of the first and second components disposed mutually exclusively in a device bay.

7. The computer peripheral of claim 1, wherein at least one of the first and second component-bus bridges comprises a chip having logic translating between a floppy disk interface and the bus interface.

8. The computer peripheral of claim 1, wherein at least one of the first and second component-bus bridges comprises a chip having logic translating between an integrated device electronics (IDE) interface and the bus interface.

9. The computer peripheral of claim 1, wherein the automatic endpoint selector comprises a switch responsive to the control signal.

10. The computer peripheral of claim 1, wherein the automatic endpoint selector comprises a first enablement control responsive to the control signal and a second enablement control responsive to the control signal subject to an inverter, wherein the first and second enablement controls are associated with the first and second component-bus bridges, respectively.

11. The computer peripheral of claim 1, wherein the automatic endpoint selector comprises a hubless switch.

12. The computer peripheral of claim 1, wherein the automatic endpoint selector comprises a hardware switch.

13. The computer peripheral of claim 1, wherein the automatic endpoint selector is adapted to provide one of the first and second component-bus bridges mutually exclusive access to the bus interface.

14. A system, comprising:
a peripheral device communicatively coupled to a processor-based device via a communication bus, comprising:
an interface to the communication bus;
a housing adapted to receive at least one selected component of a plurality of components;
a first component-bus bridge communicable with the interface;
a second component-bus bridge different from the first component-bus bridge and communicable with the interface; and
an automatic selector responsive to insertion of the at least one selected component and adapted to enable one and disable the other of the first and second component-bus bridges.

15. The system of claim 14, wherein the automatic selector comprises a hubless switch.

16. The system of claim 14, wherein the automatic selector comprises a hardware switch.

17. The system of claim 14, wherein the housing comprises a multi-component connector having a first and second connector section coupled with the first and second component-bus bridges, respectively.

18. The system of claim 14, wherein the automatic selector comprises a multi-component connector having a control signal connector.

19. The system of claim 18, wherein the control signal connector has grounded and ungrounded positions corresponding to first and second control signals.

20. A multi-component device, comprising:
means for communicatively bridging a first component interface with an externally hosted communication bus;
means for communicatively bridging a second component interface different from the first component interface with the externally hosted communication bus; and
means for mutually exclusively engaging one of the means for communicatively bridging the first and second components in response to a triggering event.

21. The multi-component device of claim 20, wherein each of the means for communicatively bridging comprises a component-bus bridge chip.

22. The multi-component device of claim 20, wherein the means for mutually exclusively engaging comprises an enable/disable switch for at least one of the means for communicatively bridging the first and second component interfaces.

23. The multi-component device of claim 20, wherein the means for mutually exclusively engaging comprises an event-activated control for at least one of the means for communicatively bridging the first and second component interfaces.

24. The multi-component device of claim 20, wherein the means for mutually exclusively engaging comprises a hubless switch.

25. The multi-component device of claim 20, wherein the means for mutually exclusively engaging comprises a hardware switch.

26. A method of forming a multi-component device, comprising:
providing a plurality of communication bridges between a communication bus interface and different component interfaces;
coupling the different component interfaces to an automatic selector able to enable one and disable others of the different component interfaces in response to a component event associated with the specific interface.

27. The method of claim 26, wherein providing a plurality of communication bridges comprises communicatively bridging a universal serial bus interface to different computer component interfaces.

28. The method of claim 26, wherein providing a plurality of communication bridges comprises communicatively bridging an Institute of Electrical and Electronics Engineers (IEEE)-1394 interface to different computer component interfaces.

29. The method of claim 26, wherein providing a plurality of communication bridges comprises communicatively bridging a computer bus interface to an integrated electronics interface.

30. The method of claim 26, wherein providing a plurality of communication bridges comprises communicatively bridging a computer bus interface to a floppy disk interface.

31. The method of claim 26, wherein coupling the different component interfaces to the automatic selector comprises coupling an enable/disable switch to at least one of the different component interfaces.

32. The method of claim 26, wherein coupling the different component interfaces to the automatic selector comprises coupling a hubless switch to at least one of the different component interfaces.

33. The method of claim 26, wherein coupling the different component interfaces to the automatic selector comprises coupling a hardware switch to at least one of the different component interfaces.

34. The method of claim 26, comprising mutually exclusively housing at least one selected component from a plurality of components in the multi-component device.

35. A method of communicating with a multi-component device, comprising:
engaging one interface of different component interfaces upon a component event; and
switchably bridging the one interface between the different component interfaces with a communication bus interface in response to the component event.

36. The method of claim 35, wherein engaging one interface comprises mutually exclusively receiving a selected component of a plurality of different components into a bay of the multi-component device.

37. The method of claim 35, wherein switchably bridging comprises activating a bridge between the one interface and the communication bus interface.

38. The method of claim 37, wherein switchably bridging comprises deactivating bridges with the remaining interfaces of the different component interfaces.

39. The method of claim 35, wherein switchably bridging comprises switching without a hub.

40. The method of claim 35, wherein switchably bridging comprises switch with a hardware switch.
